(19) United States
(12) Patent Application Publication
(10) Pub. No.: US 2003/0067417 A1
(43) Pub. Date: Apr. 10, 2003

(54) Carryon device having functions of both data displaying and timing

(76) Inventor: Yuan-Sung Weng, Taipei (TW)

Correspondence Address: BACON & THOMAS, PLLC, 625 SLATERS LANE, FOURTH FLOOR, ALEXANDRIA, VA, 22314

(21) Appl. No.: 10/253,814

(22) Filed: Sep. 25, 2002

(30) Foreign Application Priority Data
Oct. 5, 2001 (TW) 90217045

(51) Int. Cl. G09G 5/00

(52) U.S. Cl. 345/1.1

(57) ABSTRACT

The invention provides a carryon device having functions of both data displaying and timing, which is characterized in that a Super Twisted-Nematic liquid crystal display and a Twisted-Nematic liquid crystal display are used to display data and time previously stored in the device or downloaded from external devices, respectively, wherein two separate batteries are provided to power these two displays so as to achieve an effect of increasing the efficiency of power usage.

### FIELD OF THE INVENTION

The present invention relates to a carryon device having functions of both data displaying and timing, especially to a carryon device having functions of both data displaying and timing with increased efficiency of power usage.

### BACKGROUND ART

At present, the only manufacturer has put into market a carryon device having functions of both digital photographing and timing is Casio of Japan. As disclosed in Japanese Patent Application 60-148263, such carryon device, which is switchable between a timing mode and a photographing mode, uses a single liquid crystal display to display time in timing mode and to display image in photographing mode and is supplied with a single battery. Thus, this single display must be supplied with power in either photographing mode or timing mode to display data or time. In order to display a frame with sufficient clearness so as to facilitate user of image observation, such display must have sufficient resolution and size, for example, a display on one of the Casio product has a Super Twisted-Nematic (hereinafter referred as STN) liquid crystal display of 14,400 pixels and 20 mm×20 mm. However, this display requires more electric power supply in comparison with a display originally only used for time displaying due to continuously display time even if no image display is performed. Therefore, such product has high power consumption and needs to replace battery frequently, for example, the Casio made product can only last for six months under timing mode that may cause inconvenience for user. However, practically we don't need a display of large size and high resolution like the one use for image displaying, instead a display of less power consumption (e.g., of smaller size and lower resolution) exclusively for time displaying is used to reduce the power consumption in timing mode and further reduce the entire power consumption of the display to extend the life of the battery. Furthermore, since only one battery is used to provide power supply, when the battery can no longer supply the electric power such product may lose its basic function of time displaying. Moreover, since the pre-charged electricity of the battery is limited, one can only use a 16 gray scale display instead of a color display (due to huge power consumption) for image displaying to avoid the disadvantage of fast power consumption that might result in frequent battery replacing even when only timing mode is performed. Therefore, if two batteries are used to power displays for displaying image and time, only the function of photographing is lost even when shortage of the electricity occurred in the battery of the image display. The display for time displaying powered by another battery can still be functioning to maintain the fundamental function of time displaying, so that there is less constraint in the selection of display for image displaying.

### SUMMARY OF THE INVENTION

Therefore, an object of present invention is to provide a carryon device having functions of both data displaying and timing, which is capable of reducing power consumption while performing the function of timing.

Another object of present invention is to provide a carryon device having functions of both data displaying and timing, which is capable of increasing the efficiency of power usage.

Further object of present invention is to provide a carryon device having functions of both data displaying and timing, which is capable of displaying data downloaded from external devices.

Still further object of present invention is to provide a carryon device having functions of both data displaying and timing, which is capable of displaying data previously stored in the memory.

To achieve above objects, a carryon device having functions of both data displaying and timing is provided according to present invention, including a case, a circuit unit, a memory, a Super Twisted-Nematic liquid crystal display, a Twisted-Nematic liquid crystal display and two batteries. The case has a first wall, a second wall facing the first wall and at least one third wall located between the first wall and the second wall to define a receiving space. The circuit unit is placed in the receiving space of the case and has functions of data processing, timing, and action controlling of each member. The memory is controlled by the circuit unit and is used for data storage. The Super Twisted-Nematic liquid crystal display is implanted on the wall of the case and is electrically connected to the circuit unit, for displaying data stored in the memory under the control of the circuit unit. The Twisted-Nematic liquid crystal display is implanted on the wall of the case and is electrically connected to the circuit unit, for displaying time of the circuit unit, and the Twisted-Nematic liquid crystal display has a smaller size than the Super Twisted-Nematic liquid crystal display. The two batteries are used to supply electric power required by the Super Twisted-Nematic liquid crystal display and the Twisted-Nematic liquid crystal display as well as other corresponding members of the carryon device.

### BRIEF DESCRIPTION OF DRAWINGS

The above and other features and advantages of present invention will become more apparent from the detailed description in conjunction with the following drawings:

FIG. 1 is a schematic drawing, showing a carryon device having functions of both data displaying and timing in accordance with a preferred embodiment of present invention; and

FIG. 2 is a block diagram, showing a structure of the carryon device in FIG. 1.

### DETAILED DESCRIPTION OF THE INVENTION

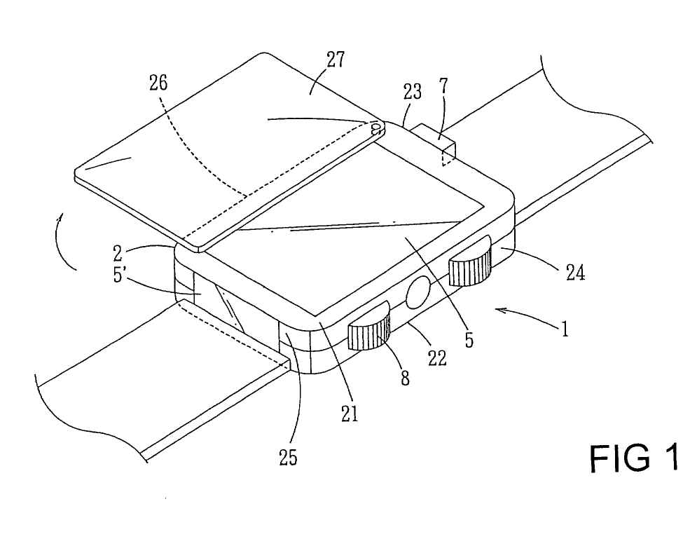

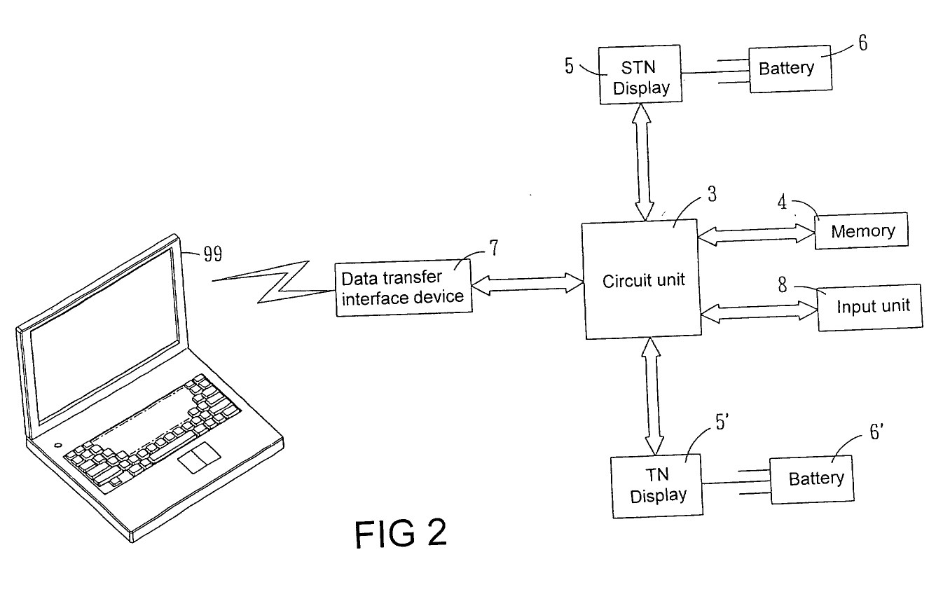

Referred to FIGS. 1 and 2, a description is made to a carryon device 1 having functions of both data displaying and timing in accordance with a preferred embodiment of present invention. The preferred embodiment is a watch type carryon device including a case 2, a circuit unit 3, a memory 4, a Super Twisted-Nematic (STN) liquid crystal display 5, a Twisted-Nematic (TN) liquid crystal display 5′, two batteries 6,6′, a data transmission interface element 7 and a input unit 8. The case 2 is a rectangular case having a first wall 21, a second wall 22 facing the first wall 21 and four third walls 2326 located between the first wall 21 and the second wall 22 to define a receiving space. With these walls 21-26, the positioning and receiving of other members are performed. The first wall 21 is implanted with a STN liquid crystal display 5, and one of the third walls 23 is implanted with a TN liquid crystal display 5′. The size of the STN liquid crystal display 5 can be increased without being restricted to the area occupied by the TN liquid crystal display 5′. In this embodiment, to facilitate the user of data observation, a convex lens 27 pivotally covering the STN liquid crystal display is mounted on the first wall 21 to achieve the effect of image magnification. Two batteries 6,6′ (not shown) are implanted on the second wall 22. Further, a circuit unit 3 and a memory 4 are placed in the receiving space inside the case 2, data transmission interface element 7 is implanted on one of the third walls 23, an input unit 8 is implanted on another third wall 24. Although the above description has specified the shape of case 2 and the location of each member 3-8 on the case, various modifications can be made according to the need of the designer and are not limited to such embodiment. For example, a TN liquid crystal display 5′ can also be implanted on another third wall, so as to minimize the observation time as well as to reduce the area of the first wall.

The circuit unit 3 is electrically connected to the memory 4, the STN liquid crystal display 5, the TN liquid crystal display 5′, the batteries 6,6′, the data transmission interface element 7 and the input unit 8. The circuit unit 3 has functions of data processing, timing, and action controlling of each member 4, 5, 5′, 6, 6′, 7, and 8.

The memory 4 is used for data storage. Thus, the user can update data at appropriate time as needed by means of the data previously stored in the memory 4 or data downloaded from external electronic devices via data transmission interface element 7 and stored in memory 4. In the case of displaying data on the STN liquid crystal display 5 for observation, the user can use the input unit 8 to control circuit unit 3 and acquire corresponding data from the memory 4 and transmit such data to the STN liquid crystal display 5 for illustration. In such a manner, the user can view the desired form of data such as image, character, and data at any time.

The STN liquid crystal display 5 may use the circuit unit 3 to receive data and correspondingly display a frame under the control of the circuit unit. The TN liquid crystal display 5′ may display time received from the circuit unit 3 under the control of the circuit unit. In this embodiment, a TN liquid crystal display consumes less power than a STN liquid crystal display under the same condition (i.e., with same size and resolution), therefore a TN liquid crystal display is adapted for time displaying to reduce power consumption in timing mode. The size of time displaying TN liquid crystal display 5′ can be made smaller in comparison to the size of the data displaying STN liquid crystal display 5, thus, the power consumption of performing the timing mode can be more efficiently reduced relative to the power consumption of performing the function of data displaying.

One of the two batteries 6 is used to supply power for members performing data displaying such as part of circuit unit 3 used for data processing, memory 4, STN liquid crystal display 5 and data transmission interface element 7 in such carryon device 1. Another battery 6′ is used to supply power for members performing time displaying such as remaining part of circuit unit (e.g., control and timing part of the circuit) 3 used for time displaying, TN liquid crystal display 5′ and input data 8 in such carryon device 1. With this, one can easily achieve in this embodiment to independently supply power for timing mode and data displaying mode. It is then possible to stop battery 6 from supplying power to the STN liquid crystal display 5 when no data displaying is performed to effectively reduce power consumption and increase the efficiency of power usage. Even if it consumes more electric power to perform data displaying, the life of the timing mode is not effected due to a battery 6′ is exclusively used for time displaying. Thus in comparison with prior carryon device, this embodiment can effectively extend the life of timing mode (i.e. up to about 5 years in life). Also, the STN liquid crystal display 5 for data displaying no longer need to take into account the life shortening of timing mode, a color STN liquid crystal display can be adapted to achieve the effect of presenting color image.

The data transmission interface element 7 is electrically connected to the circuit unit 3 for receiving data to achieve the object of downloading data from external electronic devices having the same data transmission interface specification. Further, as shown in FIG. 2, in this embodiment, the data transmission interface element 7 is a radio receiver/transmitter having function of two-way data transmission that allow user to control data downloading from both ends of such carryon device and electronic device 1 without line connection therebetween. For example, the data transmission interface element 7 is an infrared receiver/transmitter and the electronic device 1 is a notebook computer having such an infrared receiver/transmitter. With such device, the user can view data via an infrared receiver/transmitter to download desired data which is not existed in the memory 4 of this carryon device 1 from a notebook computer 99 and to store the data in the memory 4. Thereafter, the user may instruct the circuit unit 3 to acquired data from memory 4 and transmitted such data to the STN liquid crystal display 5 for data displaying as desired, so that data displaying is made more abundant and variable. Note that the present invention is described in terms of infrared receiver/transmitter and notebook computer, those who skilled in prior art should understand that the data transmission interface elements of the carryon device need only be adapted to the function of data receiving. Such data transmission interface element may have other types such as electric connector and blue tooth radio transmitter. The external electronic device may be other electronic devices such as personal data assistant (PDA) and desk top computer with a data transmission interface element of the same specification as the data transmission interface element 7 of the carryon device 1, but not limited to embodiments described in present invention.

The input unit 8 has several control buttons and is electrically connected to circuit unit 3 for user to control carryon device 1, and the circuit unit 3 may control the action of each member in accordance with the variation of input signal from the input unit. With this, the user can use the input unit 8 to control whether or not to perform the switching of the carryon device 1.

As described above, since the carryon device 1 of present invention uses a STN liquid crystal display 5 and a smaller TN liquid crystal display 5′ to display data and time, respectively, the power supply required for timing mode is effectively reduced in comparison to the prior art. It is then possible to simultaneously display data and time to achieve an effect of more convenience. Further, since the STN liquid crystal display 5 and the smaller TN liquid crystal display 5′ are powered with different batteries 6,6′, respectively, the power supply of the STN liquid crystal display 5 from battery 6 can be cutoff so as to effectively reduce entire power consumption and increase the efficiency of power usage. Thus the effective life of timing can be extended and it is possible to display color-frame with the STN liquid crystal display 5. Furthermore, in this embodiment, the memory 4 is used to store pre-stored data for user to view data at any time. Since the data transmission interface element 7 has a function of data receiving for the carryon device 1 of the embodiment to download data from external electronic devices and proceed to display data of more variable.

Therefore, the time display unit preferably posses its own independent power source to prevent the battery from being frequently replaced owing to large power consumption of the data displaying unit, and to prevent the time display unit from being iteratively adjusted due to the frequent battery replacement. Furthermore, there is no need to have a large size and a color display to show the time. Thus, the present invention provides a novel carryon device having functions of both data displaying and timing, which employs two displays and discrete power sources, as well as commonly uses a same input unt for controlling these two displays, discrete power sources and relevant circuit units.

Above descriptions are preferred embodiments of the invention but not intended to be the limit of the invention, for example, the present invention is not limited to watch type but can be a pendant watch, which means various change and modification without departing from the claim must be considered as fall within the scope of the invention.

List of Reference Numerals

1 carryon device

2 case

3 circuit unit

4 memory

5 STN liquid crystal display

5′ TN liquid crystal display

6 battery

6′ battery

7 data transmission interface element

8 input unit

21 first wall

22 second wall

23-26 third walls

27 convex lens

99 notebook computer

What is claimed is:

1. A carryon device having functions of both data displaying and timing, comprising:
a case having a first wall, a second wall facing the first wall and at least one third wall located between the first wall and the second wall to demarcate a receiving space;
a circuit unit placed in the receiving space of the case and has functions of both data processing, timing, and action controlling of each member;
a memory controlled by the circuit unit and is used for data storage;
a Super Twisted-Nematic liquid crystal display implanted on the wall of the case and is electrically connected to the circuit unit, for displaying data stored in the memory under the control of the circuit unit;
a Twisted-Nematic liquid crystal display implanted on the wall of the case and is electrically connected to the circuit unit, for displaying time of the circuit unit, and the Twisted-Nematic liquid crystal display has a smaller size than the Super Twisted-Nematic liquid crystal display; and
two batteries for supplying electric power required by the Super Twisted-Nematic liquid crystal display and the Twisted-Nematic liquid crystal display as well as other corresponding members of the carryon device.

2. The carryon device having functions of both data displaying and timing as set forth in claim 1, further comprises a convex lens covering on the Super Twisted-Nematic liquid crystal display for magnifying the display frame.

3. The carryon device having functions of both data displaying and timing as set forth in claim 1, further comprises a input unit implanted on the third wall of the case and is electrically connected to a circuit unit for inputting a control signal to the circuit unit, wherein the circuit unit may correspondingly control other members of the carryon device in accordance with the control signal.

4. The carryon device having functions of both data displaying and timing as set forth in claim 1, wherein the circuit unit will stop the two batteries from supplied power to the Super Twisted-Nematic liquid crystal display when there is no data to be displayed.

5. The carryon device having functions of both data displaying and timing as set forth in claim 1, further comprises a data transmission interface element electrically connected to the circuit unit for receiving data from external devices.

6. The carryon device having functions of both data displaying and timing as set forth in claim 5, wherein the data transmission interface element is a two-way data transmission interface element for receiving and transmitting data.

7. The carryon device having functions of both data displaying and timing as set forth in claim 5 or 6, wherein the data transmission interface element is an IR receiver/transmitter.

8. The carryon device having functions of both data displaying and timing as set forth in claim 5 or 6, wherein the data transmission interface element is implanted on one of the third walls of the case.

9. The carryon device having functions of both data displaying and timing as set forth in claim 1, wherein the Twisted-Nematic liquid crystal display is implanted on another third wall of the case.

10. A carryon device having functions of both data displaying and timing, comprising:
a case having a first wall, a second wall facing the first wall and at least one third wall located between the first wall and the second wall to define a receiving space;
a circuit unit placed in the receiving space of the case and has functions of data processing, timing, and action controlling of each member;
a memory controlled by the circuit unit and is used for data storage;
a data transmission interface element electrically connected to the circuit unit for receiving data from external devices, and for storing received data in the memory under the control of the circuit unit;
a Super Twisted-Nematic liquid crystal display implanted on the wall of the case and is electrically connected to the circuit unit, for retrieving data from the memory using the circuit unit, and is used to display a frame in accordance with such data;
a Twisted-Nematic liquid crystal display implanted on the wall of the case and is electrically connected to the circuit unit, for displaying time of the circuit unit, and the Twisted-Nematic liquid crystal display has a smaller size than the Super Twisted-Nematic liquid crystal display; and
two batteries for supplying electric power required by the Super Twisted-Nematic liquid crystal display and the Twisted-Nematic liquid crystal display as well as other corresponding members of the carryon device.

11. The carryon device having functions of both data displaying and timing as set forth in claim 10, further comprises a convex lens covering on the Super Twisted-Nematic liquid crystal display for magnifying the displayed frame.

12. The carryon device having functions of both data displaying and timing as set forth in claim 10, further comprises a input unit implanted on the third wall of the case and is electrically connected to a circuit unit for inputting a control signal to the circuit unit, wherein the circuit unit may correspondingly control other members of the carryon device in accordance with the control signal.

13. The carryon device having functions of both data displaying and timing as set forth in claim 10, wherein the circuit unit will stop the two batteries from supplied power to the Super Twisted-Nematic liquid crystal display when there is no data to be displayed.

14. The carryon device having functions of both data displaying and timing as set forth in claim 10, wherein the data transmission interface element is a two-way data transmission interface element for receiving and transmitting data.

15. The carryon device having functions of both data displaying and timing as set forth in claim 10 or 14, wherein the data transmission interface element is an IR receiver/transmitter.

16. The carryon device having functions of both data displaying and timing as set forth in claim 10 or 14, wherein the data transmission interface element is implanted on one of the third wall of the case.

17. The carryon device having functions of both data displaying and timing as set forth in claim 10, wherein the Twisted-Nematic liquid crystal display is implanted on another third wall of the case.
